(19) United States
(12) Patent Application Publication
(10) Pub. No.: US 2008/0082524 A1
(43) Pub. Date: Apr. 3, 2008

(54) APPARATUS, METHOD AND COMPUTER PROGRAM PRODUCT FOR SELECTING INSTANCES

(75) Inventors: Masumi Inaba, Kanagawa (JP); Shinichi Nagano, Kanagawa (JP); Takahiro Kawamura, Tokyo (JP); Tetsuo Hasegawa, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/849,723

(22) Filed: Sep. 4, 2007

(30) Foreign Application Priority Data
Sep. 28, 2006 (JP) 2006-265770

(51) Int. Cl. G06F 17/30

(52) U.S. Cl. 707/5; 707/E17.014

(57) ABSTRACT

An instance selecting apparatus stores a plurality of instances each of which includes an item name and an item value. The item name denotes the name of an item, whereas the item value denotes the value of the item. When having received a meta information that includes an item name and an item value, the instance selecting apparatus calculates, for each of the instances, a relevance degree showing a relationship between the instance and the meta information, by applying a weighting coefficient to a level of similarity between the meta information and at least one of the item name and the item value of the instance. The instance selecting apparatus then selects one or more of the instances having a higher level of relevance with the meta information, based on the relevance degrees.

### CROSS-REFERENCE TO RELATED APPLICATIONS

This application is based upon and claims the benefit of priority from the prior Japanese Patent Application No. 2006-265770 filed on Sep. 28, 2006; the entire contents of which are incorporated herein by reference.

### BACKGROUND OF THE INVENTION

1. Field of the Invention

The present invention relates to an apparatus, a method and a computer program product for selecting one or more instances having a higher level of relevance with predetermined meta information than other instances.

2. Description of the Related Art

An ontology is a model of a target world obtained with a specific perspective by using a knowledge representation language. Generally speaking, an ontology is expressed by using a tree structure in which a plurality of vocabulary words representing concepts are connected to one another based on their relationships.

Typical examples of the relationships (i.e., properties) based on which the vocabulary words are connected to one another include “is-a” (superordinate-subordinate), “part-of” (part-whole), and “instance-of” (concretization). There is a specific property for each concept.

In an ontology, because the relationships among the plurality of vocabulary words are systemized, it is possible to understand their correlations. Thus, it is possible to conduct a search at a more advanced level based on the correlations. Also, by referring to the tree structure in an ontology, it is possible to obtain an instance of a concept positioned around a specific concept. As explained above, by using an ontology, it is possible to obtain appropriate vocabulary words in response to a request from a user.

For example, in JP-A 2004-341672 (KOKAI) (hereinafter, “the first document”), a technique is proposed by which, by using an ontology, it is possible to obtain meta information out of the ontology, based on words included in a user's conversation. According to this technique, it is possible to provide the user with information in which the user is considered to be interested, based on the user's conversation.

However, the technique disclosed in the first document has a problem where, in a case where a large number of pieces of meta information have been obtained as a result of a search conducted in an ontology, it is not possible to narrow down the result so as to reduce the number of pieces of meta information.

### SUMMARY OF THE INVENTION

According to one aspect of the present invention, an instance selecting apparatus includes a storage unit that stores a plurality of instances each of which includes an item name and an item value, the item name denoting a name of an item in a class and the item value denoting a value of the item; a receiving unit that receives a meta information including an item name and an item value that are included in the instances specified as targets to be selected; a relevance calculating unit that calculates a relevance degree showing a relationship between the instance and the meta information for each of the instances, by applying a weighting coefficient to a level of similarity between the meta information and at least one of the item name and the item value of the instance; and a selecting unit that selects one or more instances having a higher level of relevance with the meta information from the instances based on the relevance degrees.

According to another aspect of the present invention, an instance selecting method includes receiving a meta information that includes an item name and an item value that are specified as targets to be selected, the instances each of which including an item name and an item value and being stored in a storage unit, the item name denoting a name of an item in a class, and the item value denoting a value of the item; calculating a relevance degree showing a relationship between the instance and the meta information for each of the instances, by applying a weighting coefficient to a level of similarity between the meta information and at least one of the item name and the item value of the instance; and

selecting one or more instances having a higher level of relevance with the meta information from the instances based on the relevance degrees.

A computer program product according to still another aspect of the present invention causes a computer to perform the method according to the present invention.

### BRIEF DESCRIPTION OF THE DRAWINGS

FIG. 1 is a block diagram for illustrating an information presenting apparatus according to an exemplary embodiment of the present invention;

FIG. 2 is a drawing for illustrating an example of meta data;

FIG. 3 is a drawing for illustrating an example of ontologies stored in an ontology database;

FIG. 4 is a drawing for illustrating an example of a user context;

FIG. 5 is a drawing for illustrating an example of meta data received by a meta-data-input receiving unit;

FIG. 6 is a conceptual drawing for illustrating an instance candidate list obtained out of an ontology;

FIG. 7 is a drawing for illustrating a web content that is a search result obtained by a search requesting unit from a search server;

FIG. 8 is a drawing for illustrating an example of meta data that shows basic information and has been obtained by a content analyzing unit out of meta data included in a search result;

FIG. 9 is a drawing for illustrating a first example of meta data that shows keywords and the like and that has been obtained by the content analyzing unit out of meta data included in a search result;

FIG. 10 is a drawing for illustrating a second example of meta data that shows keywords and the like and that has been obtained by the content analyzing unit out of meta data included in a search result;

FIGS. 11A to 11F are drawings for illustrating examples of item names and item values of instances shown in an instance candidate list;

FIG. 12 is a flowchart of a processing procedure performed by the information presenting apparatus to present an instance list;

FIG. 13 is a flowchart of a processing procedure performed by a relevance calculating unit to calculate, for each of instances shown in an instance candidate list, a relevance degree indicating a level of relevance, for example, between the instance and meta data or between the instance and a user context; and

FIG. 14 is a hardware diagram for illustrating the information presenting apparatus.

### DETAILED DESCRIPTION OF THE INVENTION

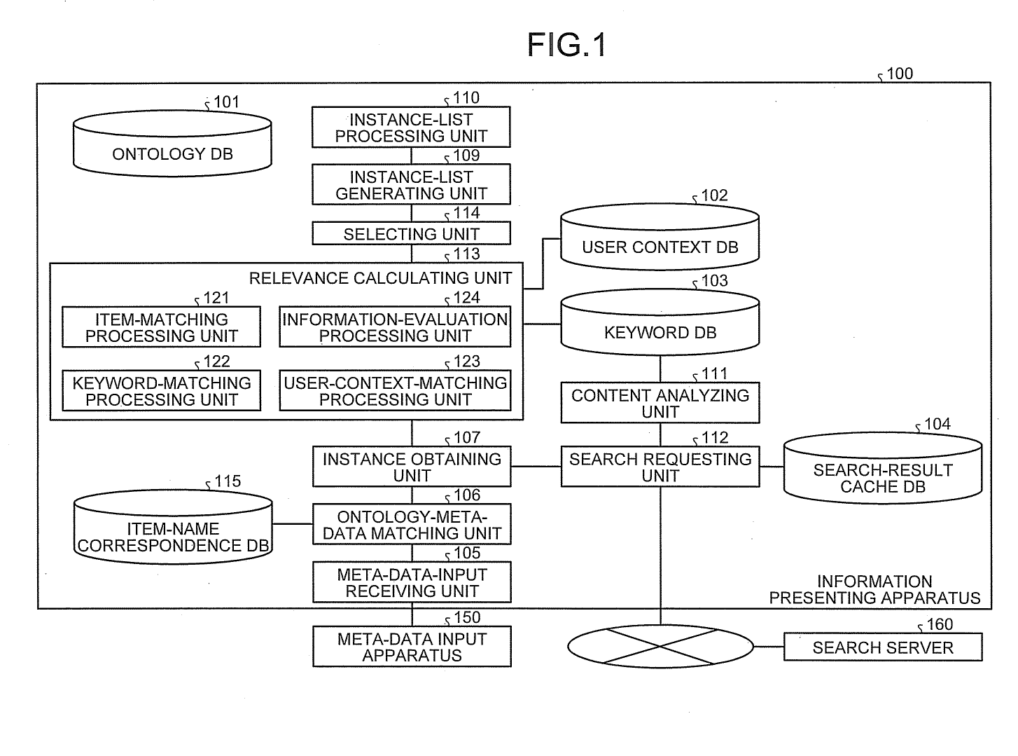

Exemplary embodiments of the present invention will be explained. As shown in FIG. 1, an information presenting apparatus 100 is connected to a meta-data input apparatus 150 and is also connected to a search server 160 via a network. The information presenting apparatus 100 includes: an ontology database 101, a user context database 102; a keyword database 103; a search-result cache database 104; a meta-data-input receiving unit 105; an ontology-meta-data matching unit 106; an instance obtaining unit 107; a relevance calculating unit 113; a selecting unit 114; an instance-list generating unit 109; an instance-list processing unit 110; a content analyzing unit 111; a search requesting unit 112; and an item-name correspondence database 115.

In the description of an exemplary embodiment below, an example will be used in which the present invention is applied to an ontology written in, for example, a Web Ontology Language (OWL) of which the standardization has been pursued by the World Wide Web Consortium (W3C). However, it is acceptable to use any other method to write ontologies.

The meta-data input apparatus 150 is an apparatus that inputs meta data to the information presenting apparatus 100 and requests that an instance list relevant to the meta data should be presented. The meta-data input apparatus 150 is configured so as to be connectable to the information presenting apparatus 100 via a public communication line or in a wireless or wired manner. The meta-data input apparatus 150 may be any type of device as long as it is operable to input the meta data to the information presenting apparatus 100. For example, the meta-data input apparatus 150 may be a mobile phone.

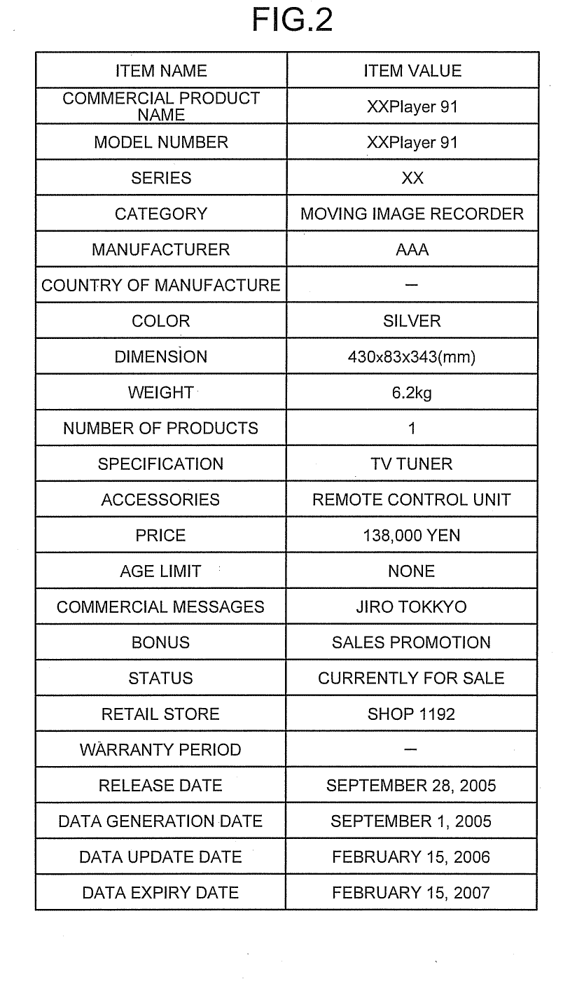

The meta data is semi-structured data that is constituted by a set in which item names and item values are in correspondence with each other, and the item names and the item values having been specified so that one or more instances can be detected (i.e., selected). As shown in FIG. 2, in meta data, for each of items, the item name is in correspondence with the item value. For example, an item name “commercial product name” is in correspondence with an item value “XXPlayer”; an item name “category” is in correspondence with an item value “moving image recorder”; an item name “manufacturer” is in correspondence with an item value “AAA”; an item name “color” is in correspondence with an item value “silver”; an item name “release date” (i.e., the date on which the product is released for sale) is in correspondence with an item value “Sep. 28, 2005”; an item name “data generation date” is in correspondence with an item value “Sep. 1, 2005”; and an item name “data update date” is in correspondence with an item value “Feb. 15, 2006”.

The search server 160 is a server that provides a service to conduct a search in information that is publicized on a network, by using a keyword or the like. The search server 160 may be any type of search server. For example, it is acceptable to apply a well-known search engine to the search server 160.

Using information included in the meta data that has been input by the meta-data input apparatus 150, the information presenting apparatus 100 obtains, out of the ontology database 101, instances that are positioned, within an ontology, at a short distance from the meta data and further selects instances having a higher level of relevance with the input meta data than other instances, out of a list showing the obtained instances. The information presenting apparatus 100 then generates a list showing the selecting instances. Next, configurations of the information presenting apparatus 100 will be explained.

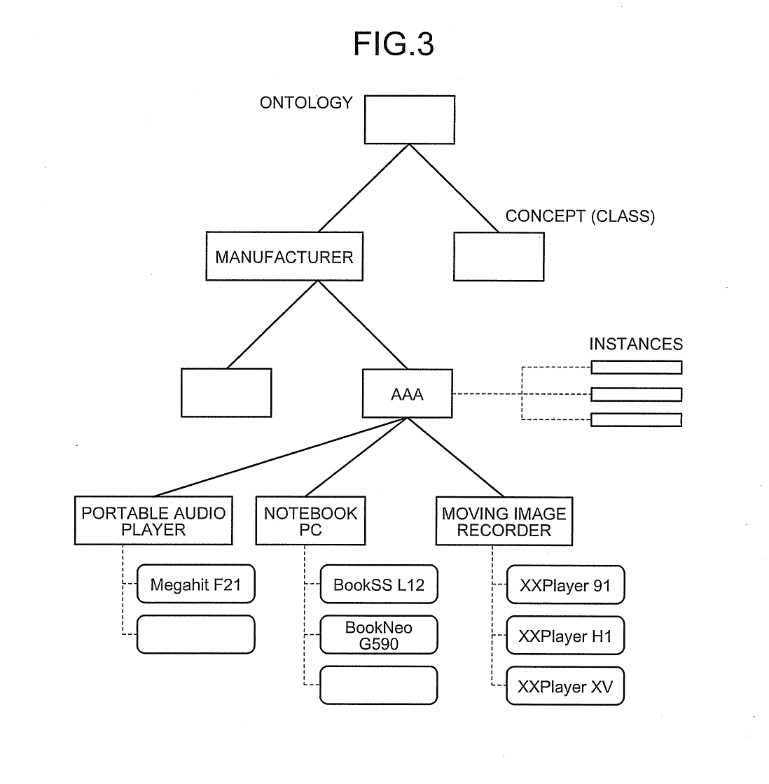

The ontology database 101 is a database that stores therein ontologies like the one shown in FIG. 3. The information presenting apparatus 100 is operable to present an instance list showing one or more instances having a higher level of relevance with the meta data that has been input, by selecting the instances out of the instances stored in the ontology database 101.

Each of the instances is data in which a class contained in the ontology is substantiated. For each of the items in the class, an item value for representing the instance is stored.

The item-name correspondence database 115 is a database that stores therein correspondence relationships among the item names. Even if the same item is represented, the item name may be different in different pieces of meta data. Thus, the item-name correspondence database 115 stores therein the correspondence among a plurality of item names that represent one same item. With this arrangement, it is possible to perform a matching process for the instances within the ontology, by using the item names contained in the meta data that has been input.

Next, examples of the correspondence relationships among the item names that are stored in the item-name correspondence database 115 will be explained. As one example, the item-name correspondence database 115 stores therein the item name “commercial product name”, an item name “manufactured product name”, and an item name “title” in correspondence with one another because these are item names that represent the “name” of a target object.

As another example, the item-name correspondence database 115 stores therein an item name “model number”, an item name “model name”, and an item name “ID” in correspondence with one another because these are item names that represent “codes for identifying” a target object. As yet another example, the item-name correspondence database 115 stores therein an item name “series”, an item name “brand”, and an item name “label” in correspondence with one another because these are item names that represent a “group” to which a target object belongs. As yet another example, the item-name correspondence database 115 stores therein an item name “category”, an item name “genre”, and an item name “classification” in correspondence with one another because these are item names that represent the “type” of a target object. As yet another example, the item-name correspondence database 115 stores therein an item name “manufacturer”, an item name “manufacturing company”, and an item name “producer” in correspondence with one another because these are item names that represent “who has made” a target object. As yet another example, the item-name correspondence database 115 stores therein an item name “color”, an item name “coloration”, and an item name “colored” in correspondence with one another because these are item names that represent the “color” of a target object.

The user context database 102 is a database that stores therein a user context for each user. Each user context is data in which information related to a user is stored. By using the information stored in a user context, it is possible to select one or more instances in which the user is interested. Like the meta data, each user context is also semi-structured data that is constituted by a set in which item names and item values are in correspondence with each other.

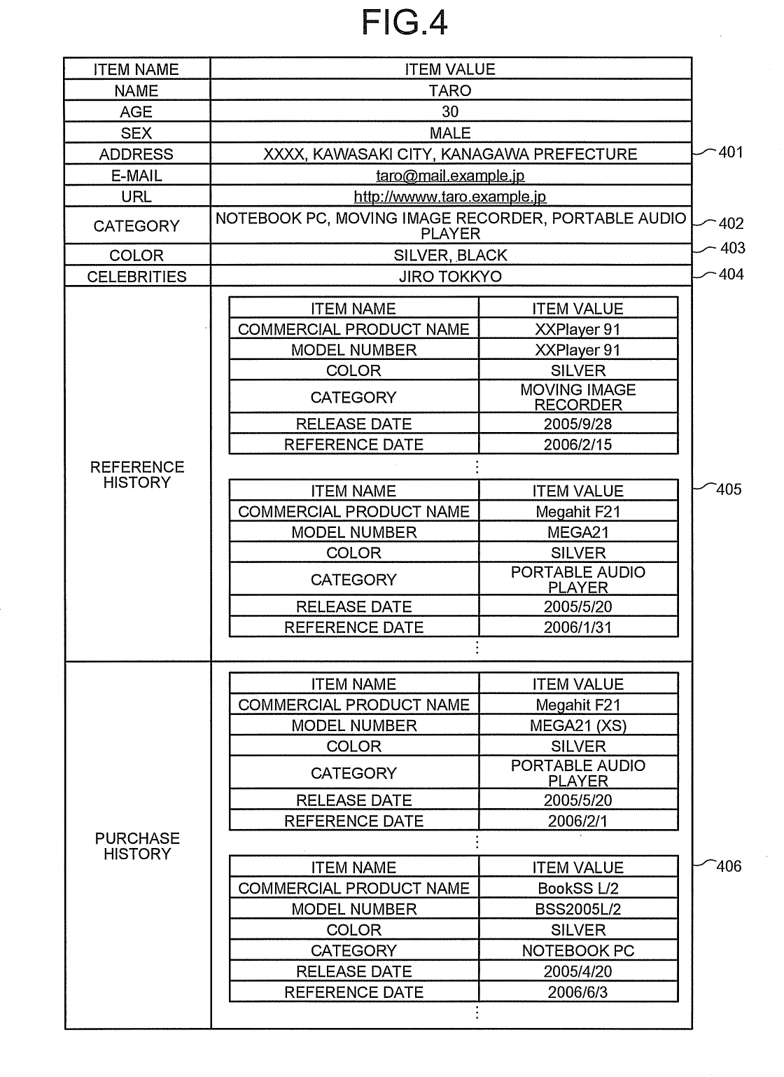

As shown in FIG. 4, in each user context, item names and item values are stored in correspondence with each other. The item names “name”, “age” “sex”, “address”, “e-mail”, and “URL” are the items that show basic information (i.e., profile) of the user.

The item names “category”, “color”, “celebrities” shown in FIG. 4 are the items that show the user's likings, preferences, and interests. Because these items are stored, it is possible to generate a list showing instances in which the user is expected to be more interested.

An item name “reference history” that is shown in FIG. 4 stores therein meta data representing commercial products that have been referred to by the user. In the stored meta data, the item names and the item values are in correspondence with each other. With this arrangement, it is possible to perform a matching process to match any of the commercial products that have been referred to by the user with one of the instances within the ontology.

An item name “purchase history” that is shown in FIG. 4 stores therein meta data representing commercial products that have been purchased by the user. In the stored meta data, the item names and the item values are in correspondence with each other. With this arrangement, it is possible to perform a matching process to match any of the commercial products that have been purchased by the user with one of the instances within the ontology.

The data structure of the user context shown in FIG. 4 is only an example. Another arrangement is acceptable in which, for example, the user's basic information, the user's likings, preferences, and interests, the user's reference history, and the user's purchase history are managed in mutually different tables.

The keyword database 103 stores therein, for example, meta data and keywords obtained by the content analyzing unit 111 out of contents. The content analyzing unit 111 will be explained later.

The search-result cache database 104 is a database that stores therein a search result obtained by the search requesting unit 112 from the search server 160. The search requesting unit 112 will be explained later.

The meta-data-input receiving unit 105 receives the input of the meta data from the meta-data input apparatus 150 and outputs the received input meta data to the ontology-meta-data matching unit 106.

As shown in FIG. 5, in the meta data, an item name “manufactured product name” is in correspondence with an item value “XXPlayer 91”; an item name “model number” is in correspondence with an item value “XXPlayer 91”; an item name “color” is in correspondence with an item value “silver”; an item name “manufacturing company” is in correspondence with an item value “AAA”; an item name “category” is in correspondence with an item value “moving image recorder”; and an item name “release date” is in correspondence with the item value “Sep. 28, 2005”. In the present embodiment, an example in which a process is performed by using the meta data described here will be explained.

The ontology-meta-data matching unit 106 refers to the ontology database 101 and performs a matching process to match the input meta data with the ontology. The ontology-meta-data matching unit 106 matches the meta data with a specific concept (i.e., a class) within the ontology stored in the ontology database 101. It is acceptable to use any method to perform the matching process, regardless of whether the method is well-known.

The instance obtaining unit 107 obtains instances of a concept that is positioned, within the ontology, at a short distance from the instance of the matched concept (for example, instances of a concept that is positioned superordinate or subordinate to the instance of the matched concept). The obtained instances will be used as the candidates for one or more instances to be presented to a user. The instance obtaining unit 107 uses a list showing the obtained instances as an instance candidate list. It is acceptable to use any method to obtain the instances of the concept that is positioned at a short distance from the meta data, regardless of whether the method is well-known.

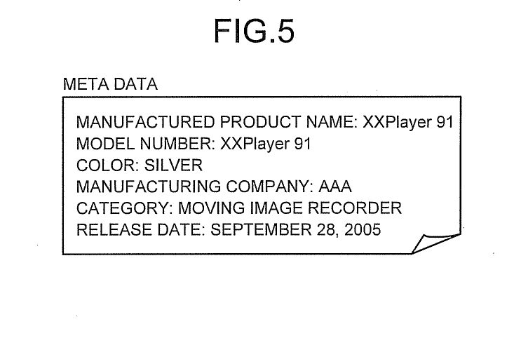

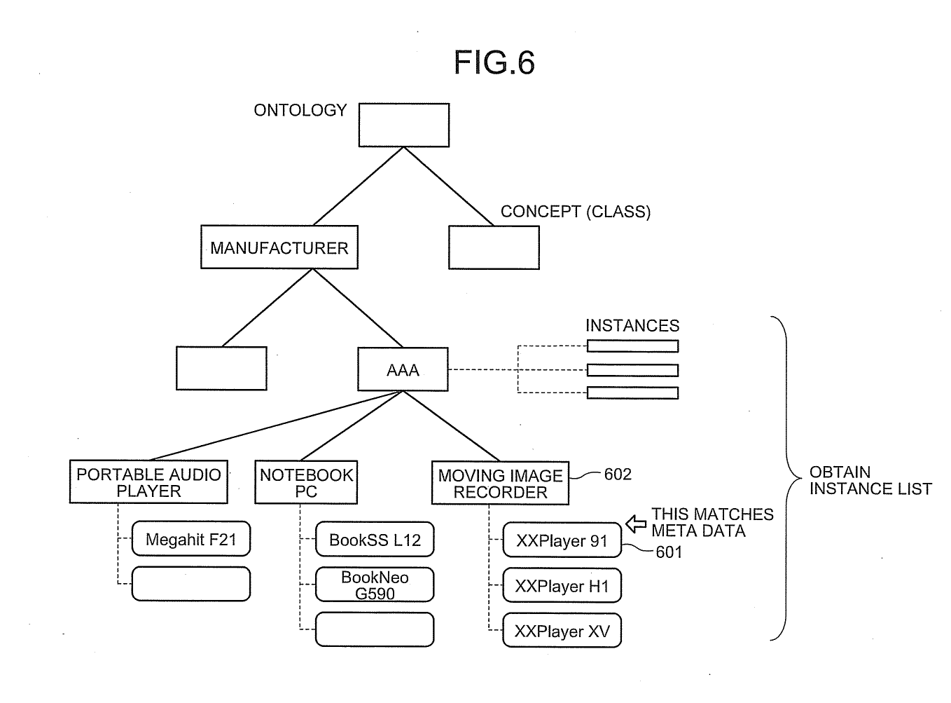

The ontology-meta-data matching unit 106 performs the matching process on the ontology shown in FIG. 6, by using the meta data shown in FIG. 5 and judges that the meta data matches a class 601. Subsequently, the ontology-meta-data matching unit 106 performs a mapping process on a concept “moving image recorder” 602 within the ontology.

The instance obtaining unit 107 collects instances that are positioned around the “moving image recorder” 602 and generates the instance candidate list. For example, to perform this collection process, it is acceptable to trace the structure from the concept “moving image recorder” up to a concept “AAA” positioned superordinate to the “moving image recorder” and obtain all the instances that are subordinate to the concept “AAA”.

The search requesting unit 112 requests the search server 160 to conduct a search for a web content in which the meta data or the instance candidates are written, by using the meta data that has been input and the instance candidate list obtained by the instance obtaining unit 107. The web content may be any type of content and may be, for example, a blog (Weblog).

The search requesting unit 112 obtains a search result based on the meta data or the instance candidates from the search server 160. After that, the search requesting unit 112 stores the search result into the search-result cache database 104 and also outputs the search result to the content analyzing unit 111.

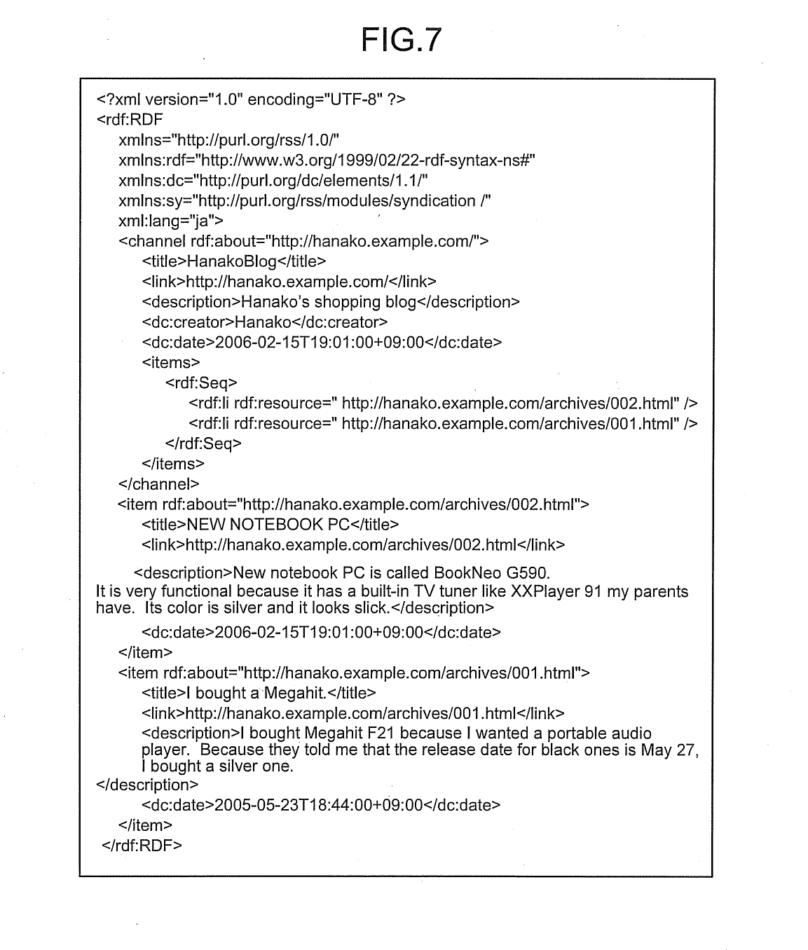

As shown in FIG. 7, a piece of meta data (RSS) is given to each web content. As explained later, the content analyzing unit 111 performs a process on meta data like this.

Out of the content included in the search result input by the search requesting unit 112, the content analyzing unit 111 extracts characteristic keywords or the like from the meta data given to the content and the main body of the content. The content analyzing unit 111 stores the extracted keywords into the keyword database 103.

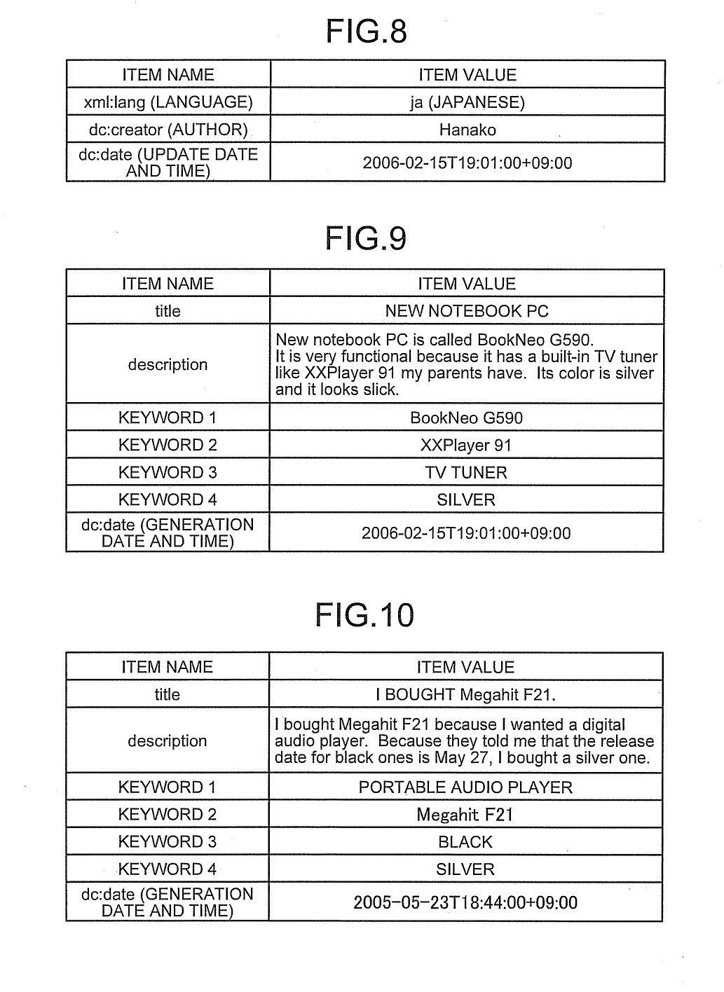

For example, the content analyzing unit 111 obtains meta data that shows basic information as shown in FIG. 8, out of the meta data included in the search result. The content analyzing unit 111 further obtains meta data that shows the keywords and the like as shown in FIGS. 9 and 10, out of the meta data included in the search result. The content analyzing unit 111 then brings the keywords 1 to 4 shown in FIGS. 9 and 10 into correspondence with one another.

In a case where the search result includes a plurality of keywords as shown in FIGS. 9 and 10, the content analyzing unit 111 brings the keywords into correspondence with one another. Subsequently, the content analyzing unit 111 stores information of the keywords that have been brought into correspondence with one another, into the keyword database 103. In other words, in a case where the meta data that has been input to the information presenting apparatus 100 contains any of these keywords, any instance that includes a keyword in correspondence with the contained keyword is arranged to have a higher relevance degree. As a result, when a relevance degree is to be calculated, it is possible to ensure that the relevance degree is calculated based on the web contents available on the public network.

The relevance calculating unit 113 includes an item-matching processing unit 121, a keyword-matching processing unit 122, a user-context-matching processing unit 123, and an information-evaluation processing unit 124. For each of the instances shown in the instance candidate list, the relevance calculating unit 113 calculates a relevance degree that is used as a reference based on which one or more of the instances are selected, with regard to the item names and the item values of the items in the instance. The relevance degree is expressed with a value that represents a relationship, for example, between the instance and the meta data or between the instance and the user context.

For each of the instances that are shown in the instance candidate list, the item-matching processing unit 121 calculates a relevance degree value by applying a weighting coefficient to a level of similarity between the item names and the item values in the instance and in the meta data. The details of this process will be explained later.

For each of the instances that are shown in the instance candidate list, the keyword-matching processing unit 122 judges whether any of the keywords stored in the item names and the item values of the meta data has been brought into correspondence, within the keyword database 103, with any of the keywords stored in the item names and the item values of the instance. The keyword-matching processing unit 122 thereby calculates a relevance degree value between each of the instances and the meta data.

In other words, the keyword-matching processing unit 122 judges whether certain keywords are compared with one another or discussed together in one web content, by judging whether these keywords have been brought into correspondence with one another in the keyword database 103. More specifically, when the keyword-matching processing unit 122 has judged that certain keywords have been brought into correspondence with one another in the keyword database 103, the keyword-matching processing unit 122 gives the instance a larger relevance degree value, on an assumption that the item value (or the item name) of the meta data and the item value (or the item name) of the instance are discussed together in the same content.

The user-context-matching processing unit 123 obtains the user context of a user who has requested, by using the meta-data input apparatus 150, that an instant list should be presented, out of the user context database 102. For each of the instances shown in the instance candidate list, the user-context-matching processing unit 123 calculates a relevance degree value indicating a level of relevance between the instance and the user, by comparing the information included in the user context with the item names and the item values included in the instance.

For each of the instances shown in the instance candidate list, the information-evaluation processing unit 124 evaluates whether the instance is suitable as information to be presented to the user and calculates a relevance degree value based on a result of the evaluation. According to the present embodiment, the information-evaluation processing unit 124 calculates, for each of the instances, a level of freshness of the information based on date information included in the instance as one of its item values. The information-evaluation processing unit 124 gives the instance a larger relevance degree value when the level of freshness is high and gives a smaller relevance degree value to the instance when the level of freshness is low. With the arrangement, it is possible to present information to the user by giving a higher priority to a piece of information that has a higher level of freshness than others. In the present embodiment, to simplify the calculation process, the level of freshness of the information is used for calculating the relevance degree values; however, it is acceptable to use any other index in the calculation.

The information-evaluation processing unit 124 according to the present embodiment also gives each of the instances a relevance degree value, in correspondence with the number of item names in the instance. With this arrangement, it is possible to present information to the user by giving a higher priority to an instance that provides more detailed information than others.

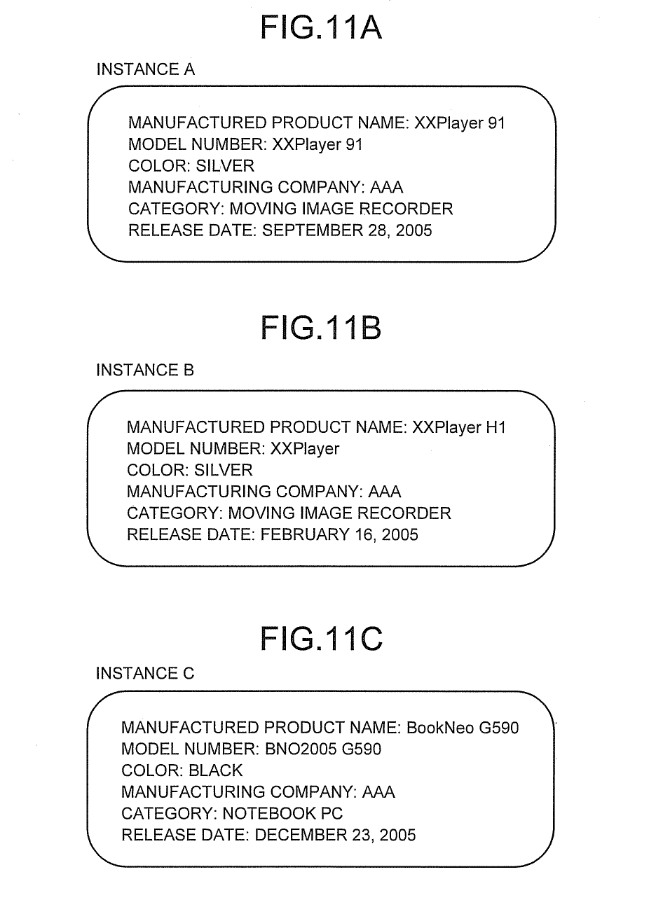

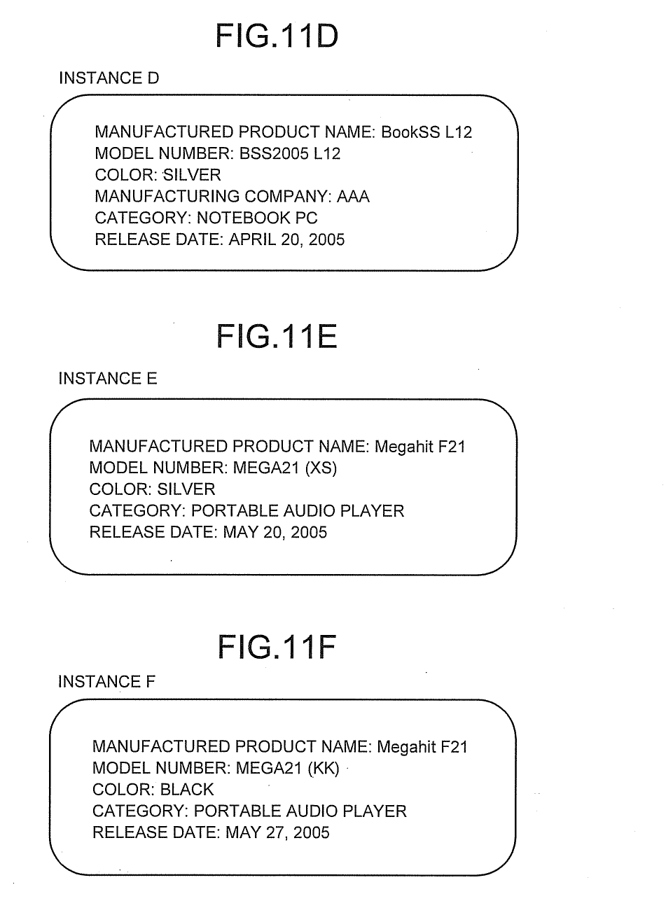

Next, examples in which relevance degree values are calculated for each of the instances will be explained. For each of the instances, the information-evaluation processing unit 124 calculates a relevance degree value between the instance and the meta data shown in FIG. 5. In the explanation below, the instance shown in FIG. 11A will be referred to as Instance A; the instance shown in FIG. 11B will be referred to as Instance B; the instance shown in FIG. 1C will be referred to as Instance C; the instance shown in FIG. 11D will be referred to as Instance D; the instance shown in FIG. 11E will be referred to as Instance E; and the instance shown in FIG. 11F will be referred to as Instance F.

First, the item-matching processing unit 121 performs a process on a basis that the larger number of item names in an instance match the item names in the meta data, the higher the level of relevance is. According to the present embodiment, the item-matching processing unit 121 gives each of the instances a relevance degree value obtained by multiplying the number of item names that match the item names in the meta data by a weighting coefficient of “8” points.

Accordingly, the item-matching processing unit 121 gives a relevance degree value of “48” points to each of Instances A to D, in each of which six items names such as “manufactured product name”, “model number”, “color”, “manufacturing company”, “category”, and “release date” match the item names in the meta data. Also, the item-matching processing unit 121 gives a relevance degree value of “40” points to each of Instances E and F.

Also, the item-matching processing unit 121 performs a process on a basis that the larger number of item values in an instance match the item values in the meta data, the higher the level of relevance is. According to the present embodiment, the item-matching processing unit 121 gives each of the instances a relevance degree value obtained by multiplying the number of item values that match the item values in the meta data by a weighting coefficient of “10” points. For example, because all of the item values in Instance A match the item values in the meta data, the item-matching processing unit 121 gives a relevance degree value of “60” points to Instance A. Because none of the item values in Instance F matches the item values in the meta data, the item-matching processing unit 121 gives a relevance degree value of “0” points to Instance F.

The item-matching processing unit 121 does not necessarily have to give a relevance degree value only when certain item values are a complete match. Another arrangement is acceptable in which the item-matching processing unit 121 gives a relevance degree value by judging that, when the numerical values in item values are close to each other, the level of relevance is high. For example, it is acceptable to give the instance a relevance degree value by using the weighting coefficient of “10” points for a complete match, as explained above, and by using a weighting coefficient of “8” points when a discrepancy in the numerical values is equal to or smaller than 20%.

For example, if a discrepancy in the item values of the item name “price” between the meta data and an instance is within a range of ±20%, the item-matching processing unit 121 judges that the price ranges are similar to each other. More specifically, if the item value of the item name “price” in the meta data is “200,000 yen”, whereas the item value of the item name “price” in a given instance is “201,000 yen”, the discrepancy is within a range of ±20%, although the numerical values are not a complete match. Consequently, the item-matching processing unit 121 gives “8” points to the instance, as the relevance degree value for the item value.

As another example, if a discrepancy in the item values of the item name “weight” between the meta data and an instance is within a range of ±20%, the item-matching processing unit 121 judges that the weights are similar to each other. More specifically, if the item value of the item name “weight” in the meta data is “3 kilograms”, whereas the item value of the item name “weight” in a given instance is “12.8 kilograms”, the discrepancy is within a range of ±20%, although the numerical values are not a complete match. Consequently, the item-matching processing unit 121 gives “8” points to the instance, as the relevance degree value for the item value.

As yet another example, if a discrepancy in the item values of the item name “number of products” between the meta data and an instance is within a range of ±20%, the item-matching processing unit 121 judges that the numbers of products in one unit of sale are similar to each other. More specifically, if the item value of the item name “number of products” in the meta data is “100”, whereas the item value of the item name “number of products” in a given instance is “90”, the discrepancy is within a range of ±20%, although the numerical values are not a complete match. Consequently, the item-matching processing unit 121 gives “8” points to the instance, as the relevance degree value for the item value.

Also, the item-matching processing unit 121 places greater importance on any item that is shared by a larger number of instances. Thus, according to the present embodiment, the item-matching processing unit 121 doubles the points in the relevance degree value described above, when the instance has any item shared by a larger number of instances.

For example, all of Instances A to F each have the item names “manufactured product name”, “model number”, “category”, and “release date”. Thus, the item-matching processing unit 121 doubles the points in the relevance degree value related to these items. More specifically, the item values of the item name “category” in the meta data and in Instance B shown in FIG. 11B are both “moving image recorder” and therefore match. Accordingly, because the points for the item name “category” should be doubled, the item-matching processing unit 121 gives Instance B “20” points, which is twice as many as the weighting coefficient of “10” points that are given when the item values match.

In addition, the item-matching processing unit 121 compares a piece of date information included in each of the instances shown in the instance candidate list with a piece of date information in the meta data. When having judged that the pieces of date information in the instance and the meta data match, the item-matching processing unit 121 judges that the level of relevance between the instance and the meta data is high. Also, not only when the pieces of date information in the instance and the meta data are a complete match, but also when the pieces of date information in the instance and the meta data are a partial match, the item-matching processing unit 121 judges that the level of relevance between the instance and the meta data is rather high.

In the following explanation, an example in which the date information is in the item name “release date” will be used. The item value “Sep. 28, 2005” in the meta data matches the item value “Sep. 28, 2005” in Instance A shown in FIG. 11A. Thus, the item-matching processing unit 121 gives a relevance degree value of “10” points to the Instance A. To summarize, with regard to the date information, the item-matching processing unit 121 gives each instance a value obtained by multiplying the number of matching item values by the weighting coefficient of “10” points.

Further, the item-matching processing unit 121 judges that the item value “Sep. 28, 2005” in the meta data partially matches the item value “Feb. 16, 2005” in Instance B shown in FIG. 11B. In other words, by focusing only on the year, the item-matching processing unit 121 judges that these products are released for sale in the same year. Thus, the item-matching processing unit 121 gives a relevance degree value of “8” points to Instance B. To summarize, with regard to the date information, the item-matching processing unit 121 gives each instance a value obtained by multiplying the number of partially-matching item values by the weighting coefficient of “8” points.

The item-matching processing unit 121 gives a relevance degree value not only for a complete match or a partial match, but also when pieces of date information are similar to each other. As an example, it is acceptable to consider that a piece of date information in the meta data is similar to a piece of date information in an instance, when the discrepancy between these pieces of date information is one month or shorter. As another example, even if the years in pieces of date information are not the same as each other, when the months therein are the same or almost the same as each other, it is acceptable to consider that these pieces of date information are similar to each other by focusing only on the month, because it means that those products are both specific to a similar season.

More specifically, with regard to the item name “release date”, because the month in the item value “Sep. 28, 2005” in the meta data matches the month in the item value “Sep. 20, 2005” in a given instance, the item-matching processing unit 121 judges that these pieces of date information are close to each other. Also, these item values satisfy the condition for being a partial match described above as well. Consequently, the item-matching processing unit 121 gives a relevance degree value of “9” points to the instance.

The number of matching item values, the number of matching item names, and the item values that completely or partially match with each other all indicate that the instance is similar to the meta data. In other words, these elements correspond to a level of similarity.

By using the search result from the web content (e.g., a blog) stored in the keyword database 103, the keyword-matching processing unit 122 calculates a weighting coefficient indicating weights to be applied to keywords and calculates a relevance degree value between each of the instances and the meta data by using the calculated weighting coefficient.

The keyword-matching processing unit 122 further calculates another weighting coefficient by placing greater importance on keywords that are more frequently compared with each other on the same page of the web content. It is acceptable to use any method to calculate the weighting coefficients. As a result, the keyword-matching processing unit 122 gives a larger relevance degree value to an instance that has an item value containing such a keyword that is more frequently compared with an item value in the meta data, on the same page of the web content.

For example, the meta data included in a search result shown in FIG. 9 contains both “BookNeo G590” and “XXPlayer 91” as keywords. Thus, it is judged that the level of relevance between these keywords is high. Because the item value in the meta data contains “XXPlayer 9111, the keyword-matching processing unit 122 gives a relevance degree value of 1110” points to Instance C that contains “BookNeo” as one of its item values. As explained here, when certain keywords are compared with each other on the same page of the web content, the keyword-matching processing unit 122 gives a relevance degree value obtained by multiplying the number of comparisons of keywords by the weighting coefficient of “10”. Also, another arrangement is acceptable in which, when date information for the web content is stored in the keyword database 103, the keyword-matching processing unit 122 changes the weighting coefficient according to the level of freshness of the date information for the web content.

In addition, the keyword-matching processing unit 122 gives a larger relevance degree value to an instance when a search is conducted by using each of the item values in the instance as a search key and a larger number of hits are obtained as a search result. According to the present embodiment, a value obtained by multiplying the number of hits with a weighting coefficient of “1” point is used as the relevance degree value. For example, let us imagine a situation in which 50 hits are obtained when a search is conducted in the search server 160 by using “BookNeo” as a keyword, and 100 hits are obtained when a search is conducted by using “XXPlayer” as a keyword. In this situation, because Instance A and Instance B each have “XXPlayer” as one of their item values, the keyword-matching processing unit 122 gives a relevance degree value of “100” points to Instance A and to Instance B. Also, because Instance C has “BookNeo” as one of its item values, the keyword-matching processing unit 122 gives a relevance degree value of “50” points to Instance C.

Another arrangement is acceptable in which, instead of counting the number of hits, the keyword-matching processing unit 122 gives a larger relevance degree value to an instance that has an item value containing such a keyword that more frequently appears in a web content in a search result hit.

The user-context-matching processing unit 123 gives a larger relevance degree value when an item value of an instance shown in the instance candidate list matches an item value in the user context.

For example, when the user context shown in FIG. 4 is used, the user-context-matching processing unit 123 judges that the user is male based on a record 401 shown in FIG. 4. Thus, the user-context-matching processing unit 123 gives a smaller relevance degree value to any instance that has an item value “for women”. According to the present embodiment, after all the calculations to calculate the relevance degree values of each of the instances having an item value “for women” are finished, the user-context-matching processing unit 123 multiplies the calculation result by “0”. With this arrangement, the instances having an item value “for women” will not be selected even if the relevance degree values from the other aspects are large. As explained here, instead of adding up the relevance degree values together, it is acceptable to apply any other calculation method to the relevance degree values, such as multiplying the relevance degree values.

When the user context shown in FIG. 4 is used, the user-context-matching processing unit 123 places greater importance on each of the item values such as “notebook PC”, “moving image recorder”, “portable audio player”, “silver”, “black”, and “Jiro Tokkyo” that are stored in records 402, 403, and 404 shown in FIG. 4. For example, when an instance contains some of these keywords as its item values, the user-context-matching processing unit 123 gives the instance a relevance degree value obtained by multiplying the number of keywords contained in the item values by a weighting coefficient of “10” points.

Also, when the user context shown in FIG. 4 is used, the user-context-matching processing unit 123 places greater importance on the meta data included in the reference history stored in a record 405 shown in FIG. 4. For example, when an instance has, as its item values, “XXPlayer 91” or “Megahit F21”, which are commercial product names in the meta data, the user-context-matching processing unit 123 multiplies a sum of the relevance degree values of the instance by “1.5”. Alternatively, it is acceptable to give the instance a predetermined number of points, as described above.

In addition, when the user context shown in FIG. 4 is used, the user-context-matching processing unit 123 places greater importance on the meta data included in the purchase history stored in the record 406 shown in FIG. 4. For example, when an instance has, as one of its item values, “Megahit F21” or “BookSS L/2”, which are commercial product names in the meta data, the user-context-matching processing unit 123 multiplies a sum of the relevance degree values of the instance by “1.2”.

As a result of these processes performed by the user-context-matching processing unit 123, it is possible to present instances to the user by giving a higher priority to some of the instances in which the user is more interested.

For each of the instances shown in the instance candidate list, the information-evaluation processing unit 124 gives a relevance degree value, according to the item names and the item values in the instance.

According to the present embodiment, the information-evaluation processing unit 124 places greater importance on an instance that has a larger number of items. For example, the information evaluation processing unit 124 gives each of the instances a relevance degree value obtained by multiplying the number of items in the instance by a weighting coefficient of “3”. With this arrangement, it is possible to present instances by giving a higher priority to an instance that provides more detailed information than others.

For example, the number of items in each of Instances A to D is 6. Thus, “18” points are given to each of Instances A to D, as a relevance degree value. On the other hand, the number of items in each of Instances E and F is 5. Thus, “15” points are given to each of Instances E and F, as a relevance degree value.

In addition, to each of the instances, the information-evaluation processing unit 124 gives a relevance degree value according to the level of freshness of the information (for example, a time gap from the current time). As a more specific example, when an instance has, as one of its item values, date information (e.g., a release date, a data generation date, or a data update date) that indicates a date less than one week before the current point in time, the information-evaluation processing unit 124 gives the instance a relevance degree value of “10” points.

Further, when an instance has, as one of its item values, date information that indicates a date one week to one month ago, the information-evaluation processing unit 124 gives the instance a relevance degree value of “8” points. Also, when an instance has, as one of its item values, date information that indicates a date one month to six months ago, the information-evaluation processing unit 124 gives the instance a relevance degree value of “5” points.

More specifically, when an instance list is requested on Dec. 28, 2005, the information-evaluation processing unit 124 gives a relevance degree value of “10” points to Instance C, which has the latest release date. With this arrangement, it is possible to present instances having a higher level of freshness to the user.

Furthermore, when an instance has, as one of its item values, date information that indicates a date 10 or more years before the current point in time, the information-evaluation processing unit 124 multiplies a sum of the relevance degree values of the instance by “0.2”. With this arrangement, it is possible to lower the possibility that instances having a lower level of freshness may be presented to the user.

The weighting coefficients explained above are only examples. It is possible to set the weighting coefficients to any appropriate values according to the situations. Also, another arrangement is acceptable in which the weighting coefficients are not the predetermined values but are values that can be changed according to the user's request. Further, yet another arrangement is acceptable in which the information presenting apparatus 100 automatically calculates the weighting coefficients based on the information stored in the user context database 102 or the keyword database 103.

The selecting unit 114 selects one or more instances having a higher degree of relevance with the meta data, out of the instance candidate list, based on the sums of the relevance degree values calculated by the relevance calculating unit 113. According to the present embodiment, the selecting unit 114 selects one or more instances of which the sum of relevance degree values is larger than a predetermined threshold value, as the instances having a higher level of relevance with the meta data.

The method for selecting the instances is not limited to the one that employs a threshold value. It is acceptable to use any other method to select the instances. As an alternative example different from the present embodiment, an arrangement is acceptable in which the selecting unit 114 selects, out of the instance candidate list, a predetermined number of instances in descending order of their relevance degree values, starting with the largest value.

The instance-list generating unit 109 generates an instance list showing the one or more instances selected by the selecting unit 114.

The instance-list processing unit 110 performs a process using the generated instance list. This process may be any type of process. For example, the instance-list processing unit 110 may output the generated instance list to the meta-data input apparatus 150 that has output the meta data. With this arrangement, it is possible to present an instance list that is relevant to the meta data to the user.

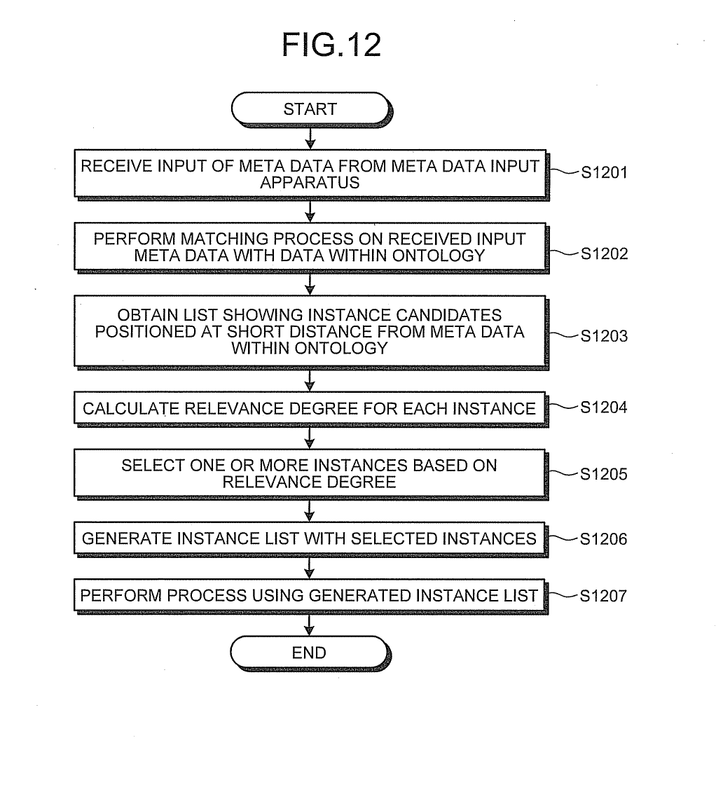

Next, a processing procedure performed by the information presenting apparatus 100 to present the instance list will be explained, with reference to FIG. 12.

First, the meta-data-input receiving unit 105 receives an input of meta data from the meta-data input apparatus 150 (step S1201).

Next, the ontology-meta-data matching unit 106 performs the matching process on the ontology stored in the ontology database 101 by using the meta data that has been input (step S1202). As a result, the position of the input meta data within the ontology is understood.

Subsequently, the instance obtaining unit 107 obtains instances of a concept that is positioned, within the ontology, at a short distance from the meta data and generates an instance candidate list showing these obtained instances (step S1203).

After that, the relevance calculating unit 113 calculates a relevance degree for each of the instances shown in the instance candidate list (step S1204). The detailed processing procedure will be explained later.

Subsequently, the selecting unit 114 selects one or more instances to be presented to the user, based on the calculated relevance degree (step S1205).

The instance-list generating unit 109 then generates an instance list showing the selected one or more instances (step S1206).

After that, the instance-list processing unit 110 performs a process using the generated instance list (step S1207). For example, the instance-list processing unit 110 presents the instance list to the user.

As a result of the processing procedure described above, it is possible to perform the process by using the instance list showing the instances having a higher level of relevance with the meta data that has been input by the meta-data input apparatus 150.

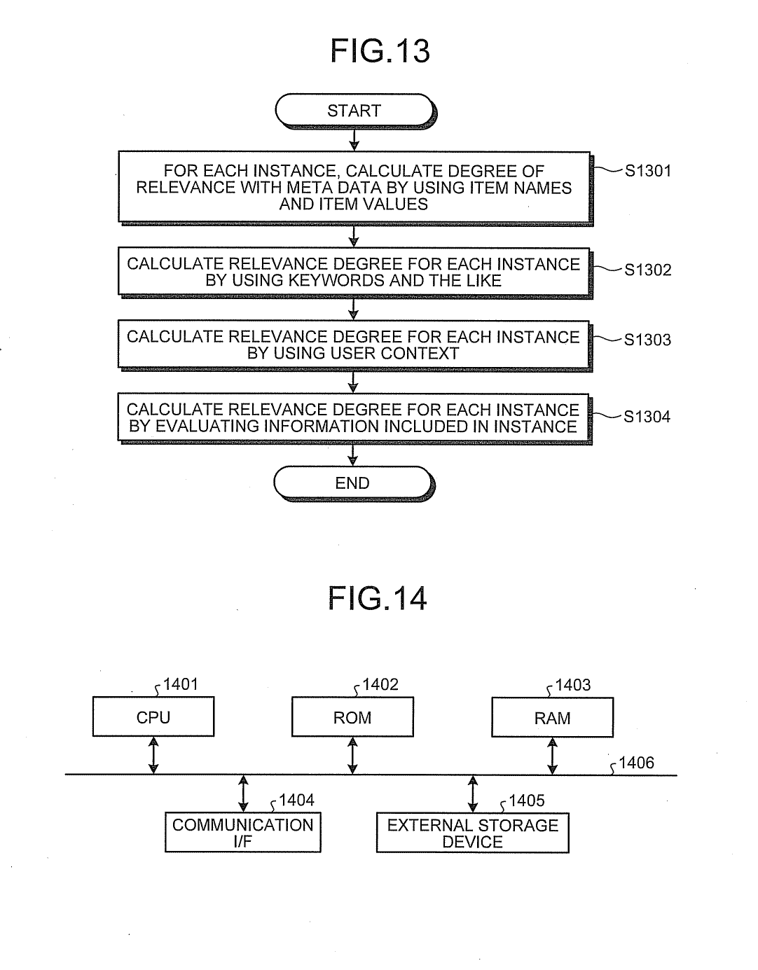

Next, with reference to FIG. 13, a processing procedure performed by the relevance calculating unit 113 to calculate, for each of the instances shown in the instance candidate list, a relevance degree indicating a level of relevance, for example, between the instance and the meta data, or between the instance and the user context, will be explained.

First, the item-matching processing unit 121 compares each of the instances shown in the instance candidate list with the meta data, by using the item names and the item values. The item-matching processing unit 121 thereby calculates, for each of the instances, a degree of relevance with the meta data (step S1301).

Subsequently, based on the information stored in the keyword database 111, the keyword-matching processing unit 122 compares, for each of the instances shown in the instance candidate list, the keywords stored in the item names and the item values of the meta data with the keywords stored in the item names and the item values of the instance and calculates, for each of the instances, a degree of relevance with the meta data (step S1302).

After that, the user-context-matching processing unit 123 calculates, for each of the instances shown in the instance candidate list, a relevance degree indicating a level of relevance between the instance and the user, by using the item names and the item values in the instance and the user context stored in the user context database 102 (step S1303).

Subsequently, for each of the instances shown in the instance candidate list, the information-evaluation processing unit 124 evaluates a level of suitability of the instance as information to be presented to the user and calculates a relevance degree based on the evaluation (step S1304). As the targets of the evaluation, it is acceptable to judge, for example, whether the number of items is large, or whether the date information is new.

As a result of the processing procedure described above, it is possible to calculate, for each of the instances, the relevance degree indicating a level of relevance between the instance and the meta data or between the instance and the user context. Based on a sum of the relevance degree values for each instance calculated in the processing procedure shown in FIG. 13, the selecting unit 114 selects one or more instances having a higher degree of relevance with the meta data, out of the instance candidate list.

Accordingly, it is possible to select, out of the instance candidate list, the instances that have a higher level of relevance with the meta data and that are suitable as the information to be presented to the user.

In other words, when an instance is detected based on whether an item name or an item value in the instance matches with an item name or an item name in the meta data, there is a possibility that a large number of instances having a matching item name or a matching item value are selected. There is also a possibility that hardly any instances having a matching item name or a matching item value are selected. To cope with this situation, according to the present embodiment, the degrees of relevance are calculated after applying a weight to each of the instances, as described above. After that, the instances having a sum of relevance degree values that exceeds the predetermined threshold value are selected. Alternatively, a predetermined number of instances are selected in a descending order of their relevance degree values, starting with the largest value. With this arrangement, it is possible to change the number of instances to be selected or the like, in a flexible manner, by changing, for example, the threshold value. Also, an arrangement is acceptable in which the user is able to change the weighting coefficients according to situations. In other words, the relevance calculating unit 113 included in the information presenting apparatus 100 according to the present embodiment is able to select suitable instances that are in compliant with different situations, because the weighting coefficients are changed accordingly.

Also, in the information presenting apparatus 100 according to the present embodiment, one or more instances are selected out of the instance candidate list, based on a sum of the relevance degree values that are calculated by the relevance calculating unit 113 for each of the instances. With this arrangement, it is possible to select the instances having a higher level of relevance with the input meta data and with the user context, for example. Thus, it is possible to improve the level of precision in the selecting process.

As shown in FIG. 14, the information presenting apparatus 100 includes, as its hardware configuration, the following elements: a Read-Only Memory (ROM) 1402 that stores therein an instance processing program and the like that are used by the information presenting apparatus 100; a Central Processing Unit (CPU) 1401 that controls the constituent elements of the information presenting apparatus 100 according to the programs stored in the ROM 1402; a Random Access Memory (RAM) 1403 that stores therein various types of data that are required for controlling the information presenting apparatus 100; a communication interface (I/F) 1404 that connects the information presenting apparatus 100 to a network; an external storage device 1405 such as a hard disk; and a bus 1406 that connects the constituent elements to one another. It is acceptable to apply any commonly-used computer having the configurations as described above to the information presenting apparatus 100.

The instance processing program executed by the information presenting apparatus 100 according to the embodiment described above is provided as being recorded in a file in an installable format or in an executable format, on a computer-readable recording medium such as a Compact Disc Read-Only Memory (CD-ROM), a Flexible Disc (FD), a Compact Disc Recordable (CD-R), or a Digital Versatile Disc (DVD).

In this situation, the instance processing program is loaded into a main storage device, when being read from the recording medium and executed by the information presenting apparatus 100 so that the functional elements explained as the software configuration above are generated within the main storage device.

Another arrangement is acceptable in which the instance processing program executed by the information presenting apparatus 100 according to the embodiment described above is stored in a computer connected to a network such as the Internet and provided as being downloaded via the network. Further, yet another arrangement is acceptable in which the instance processing program executed by the information presenting apparatus 100 according to the embodiment described above is provided or distributed via a network such as the Internet.

Furthermore, yet another arrangement is acceptable in which the instance processing program according to the present embodiment is provided as being incorporated in a ROM or the like in advance.

The instance processing program executed by the information presenting apparatus 100 according to the present embodiment has a module structure that includes the functional elements as described above. In the actual hardware, when the CPU (i.e., the processor) reads the instance processing program from the storage medium and executes the read instance processing program, the functional elements are loaded into the main storage device so that the functional elements are generated within the main storage device.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An instance selecting apparatus comprising:
a storage unit that stores a plurality of instances each of which includes an item name and an item value, the item name denoting a name of an item in a class and the item value denoting a value of the item;
a receiving unit that receives a meta information including an item name and an item value that are included in the instances specified as targets to be selected;
a relevance calculating unit that calculates a relevance degree showing a relationship between the instance and the meta information for each of the instances, by applying a weighting coefficient to a level of similarity between the meta information and at least one of the item name and the item value of the instance; and
a selecting unit that selects one or more instances having a higher level of relevance with the meta information from the instances based on the relevance degrees.

2. The apparatus according to claim 1, wherein the selecting unit selects one or more instances each of which has the relevance degree higher than a threshold value.

3. The apparatus according to claim 1, wherein the level of similarity used by the relevance calculating unit is a value that is obtained based on a degree to which the item value in each instance matches the item value in the meta information.

4. The apparatus according to claim 1, wherein the level of similarity used by the relevance calculating unit is a value that is obtained based on a degree to which the item name in each instance matches the item name in the meta information.

5. The apparatus according to claim 1, further comprising a user-context storage unit that stores a user context indicating information related to a user, wherein
the relevance calculating unit further judges for each of the instances whether at least one of the item name and the item value of the instance matches any of the information contained in the user context, and makes the relevance degree higher when a result of the judgment is affirmative.

6. The apparatus according to claim 1, further comprising:
a content obtaining unit that obtains a content accumulated in a network; and
a content analyzing unit that analyzes the content and brings a plurality of keywords extracted from the obtained content into correspondence with one another, wherein
the relevance calculating unit makes the relevance degree of the instance that has the item names and the item values including a keyword correlated to the keyword higher, when one of the keywords includes one of the item name and the item value in the meta information.

7. The apparatus according to claim 1, wherein the relevance calculating unit further changes the relevance degree of the instance according to a time gap between the date information and a predetermined point in time, when the item value of any of the instances includes date information.

8. An instance selecting method comprising:
receiving a meta information that includes an item name and an item value that are specified as targets to be selected, the instances each of which including an item name and an item value and being stored in a storage unit, the item name denoting a name of an item in a class, and the item value denoting a value of the item;
calculating a relevance degree showing a relationship between the instance and the meta information for each of the instances, by applying a weighting coefficient to a level of similarity between the meta information and at least one of the item name and the item value of the instance; and
selecting one or more instances having a higher level of relevance with the meta information from the instances based on the relevance degrees.

9. The method according to claim 8, wherein one or more instances each of which has the relevance degree higher than a threshold value are selected in the selecting.

10. The method according to claim 8, wherein the level of similarity used in the calculating is a value that is obtained based on a degree to which the item value in each instance matches the item value in the meta information.

11. The method according to claim 8, wherein the level of similarity used in the calculating is a value that is obtained based on a degree to which the item name in each instance matches the item name in the meta information.

12. The method according to claim 8, further comprising storing a user context indicating information related to a user, wherein
whether at least one of the item name and the item value of the instance matches any of the information contained in the user context is further judged in the calculating for each of the instances, and the relevance degree is made higher when a result of the judgment is affirmative.

13. The method according to claim 8, further comprising:
obtaining a content accumulated in a network; and
analyzing the obtained content and bringing a plurality of keywords extracted from the content into correspondence with one another, wherein
the relevance degree of the instance that has the item names and the item values including a keyword correlated to the keyword is made higher in the calculating, when one of the keywords includes one of the item name and the item value in the meta information.

14. The method according to claim 8, wherein the relevance degree of the instance according to a time gap between the date information and a predetermined point in time is changed in the calculating, when the item value of any of the instances includes date information.

15. A computer program product having a computer readable medium including programmed instructions for selecting an instance related to meta information, wherein the instructions, when executed by a computer, cause the computer to perform:
receiving a meta information that includes an item name and an item value that are specified as targets to be selected, the instances each of which including an item name and an item value and being stored in a storage unit, the item name denoting a name of an item in a class, and the item value denoting a value of the item;
calculating a relevance degree showing a relationship between the instance and the meta information for each of the instances, by applying a weighting coefficient to a level of similarity between the meta information and at least one of the item name and the item value of the instance; and
selecting one or more instances having a higher level of relevance with the meta information from the instances based on the calculated relevance degrees.
